(19) United States
(12) Patent Application Publication
(10) Pub. No.: US 2006/0199928 A1
(43) Pub. Date: Sep. 7, 2006

(54) Hyber-branched diacetylene polymers and their use in ceramics, photonic devices and coating films

(76) Inventors: Ben Zhong Tang, Hong Kong (CN); Matthias Haeussler, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/368,755

(22) Filed: Mar. 6, 2006

Related U.S. Application Data
(60) Provisional application No. 60/658,710, filed on Mar. 7, 2005.

(51) Int. Cl. C08F 38/00

(52) U.S. Cl. 526/285; 428/917; 257/40

(57) ABSTRACT

A diacetylene-based branched (co)polymer of the general formula (I): 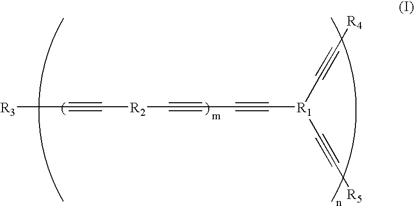
where R₁ and R₂ represent any organic group and R₃, R₄, and R₅ represent either protons from unreacted acetylene moieties or other organic groups from end-capping and/or functionalization agents, with m≧0 and n≧1, which is processable, exhibit photo- and electroluminescence, show high photo refractivity, is thermal and irradiative curable to heat and solvent resistant materials. The present invention can be blend with a variety of macromolecules for general use. The polymer can be metallified by reacting with organometallic complexes and ceramization of the obtained organic-inorganic hybrids afford ferromagnetic materials with high magnetizability.

### CROSS REFERENCE TO RELATED APPLICATION

Pursuant to 35 U.S.C. § 119(e), this application claims priority to U.S. Provisional Application Ser. No. 60/658,710 filed Mar. 7, 2005, the contents of which are hereby incorporated by reference in their entirety.

### BACKGROUND OF THE INVENTION

1. Field of the Invention

The present invention relates to novel useful organic materials. Particularly, it relates to hyper-branched organic polymers containing diacetylene moieties as one structural unit, to methods of producing such polymers, and to their various utilities.

2. Description of the Related Art

Diacetylenes or diynes are a group of two reactive carbon-carbon triple bonds connected through a single bond. Coupling monomers each possessing two acetylene functionalities will generate linear diacetylene (or diyne) containing polymers. Such polyynes are well known and there are reports dating back as far as 1967 when Hay reported their first synthesis by using equimolar amounts of catalyst and pyridine as solvent. However, he yielded in many cases only low molecular weight oligomeric products due to easy precipitation (U.S. Pat. No. 3,300,456). To achieve higher molecular mass for such polymers Hay's system was modified by White in 1971 (Polym. Prepr. 1971, 12, 155). The pyridine solvent was replaced by 1,2-dichlorobenzene and the catalyst concentration was lowered. Therewith, precipitation was no longer a problem and polymers with high molecular weight, easy to purify, were obtained (Can. J. Chem. 1995, 73, 1914). Since then, linear diacetylene-containing polymers have been the focus of research activities because of their expected high potential applications as heat and solvent resistant cured films with low dielectric characteristics and mechanical strengths (Prog. Polym. Sci. 1995, 20, 943). Such linear (co)-polymers were anticipated to find an array of innovations as insulating low-dielectric layers, surface coatings or other protective films in semiconductor elements, liquid-crystal displays and multilayered circuit boards or as gas separation membranes (cf. Akiike et al., U.S. Pat. No. 6,528,605).

Recent advances in the development of highly luminescent organic materials have also drawn the attention of researchers towards diacetylene containing materials. Pat. U.S. Pat. No. 6,344,286, Kim et al. connected light-emitting chromophores with diyne moieties and have utilized these diacetylene-based polymers as light-emitting layers in electroluminescent devices (organic light-emitting diode, OLED).

A feature common to those prior art materials is their limitation to only linear structures. Introducing branches into the polymer chains will not only change the morphology of the materials and open thus an avenue to new materials with interesting properties but will also have tremendous effect on their processability and functionality, because hyper-branched polymers are known to show much lower solution viscosity compared to their rod-like linear counterparts and the high ratio of end-groups to repeating units allows the incorporation of property-determining units on the outer shell of the polymer.

The only known example of processable branched organic materials containing diacetylene moieties was reported by Economy (U.S. Pat. No. 4,273,906). It aimed to prepare low molecular weight prepolymers by copolymerizing triethynylbenzene with large excess (up to 15 times) of a monoacetylenic capping agent. The molecular weight of the obtained oligomers were in the range of about 200 to about 10,000 Dalton and were anticipated to be useful for the fabrication of adhesives and coatings. Although this invention incorporated branches into the polyyne structure, it was only capable of preparing reactive low molecular weight materials (oligomers) of the above compounds, which were processable and their films were curable. Furthermore, with this method, large amounts of homo-coupled side products (1,4-diphenylbutadiynes) are produced. Another disadvantage arises from the fact that these low molecular weight compounds tend to crystallize instead of forming homogenous films. To overcome this problem other people have managed to prepare the films by using the comparatively expensive reactive solvents such as phenylacetylene and derivatives thereof (U.S. Pat. No. 4,258,079).

Organometallic polymers are hybrid macromolecules of organic and inorganic species and often exhibit unique magnetic, electronic, catalytic, sensoric, and optical properties. They are also potential candidates as precursors for fabrication of nanostructured materials and advanced ceramics. However, most transition metal-based polymers reported so far are thermally unstable, suffering from only low char yields upon high temperature treatment and thus exhibit only low metal-retentivity for the preparation of metal-containing ceramics. Keller et al. incorporated cross-linkable diacetylene units into the backbone of metallocene polymers (U.S. Pat. No. 5,844,052 and U.S. Pat. No. 6,770,583) and reported the efficient transformation of these materials into thermosets and ceramics in high yields. But, employing organolithium compounds into his synthetic route makes this approach not only highly moisture sensitive and therefore difficult for potential applications but also raises the production costs tremendously.

All the above-mentioned potential applications point to the need for hyper-branched diacetylene polymers and economic and efficient process of making such hyper-branched materials.

### SUMMARY OF THE INVENTION

As one object of this invention, there are provided novel non-linear, large hyper-branched (co)polymers containing diacetylene units of formula I, which are processable, easily film-forming and transformable (curable) into thermosets by heat or irradiation. The end-groups can be functionalized by various different types of chemical reactions, which can be reactions involving carbon-carbon triple bonds, e.g. palladium-catalyzed couplings with haloarylenes (Heck-type-coupling) or copper-catalyzed cyclomerizations with agents such as azides (commonly known as “Click-chemistry”), or reactions with organometallic species to furnish metal-acetylides on the outside of the branched organic polymer core. Such compounds might be useful for preparation of coatings, adhesives or as surface-modifiers.

Formula I is as follows:

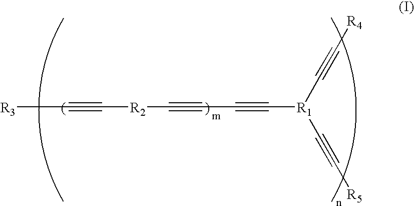

where R₁ and R₂ represent any organic group and R₃, R₄, and R₅ represent either protons from unreacted acetylene moieties or other organic groups from end-capping and/or functionalization agents, with m≧0 and n≧1.

There is also provided a synthetic method for the compound of formula (I) as follows: Scheme 1 provides a method for making the compound of the present invention with unreacted triple bonds at the end (outside) while scheme 2 is a method for making the compound with terminated triple bonds through copolymerization with monoacetylenes.

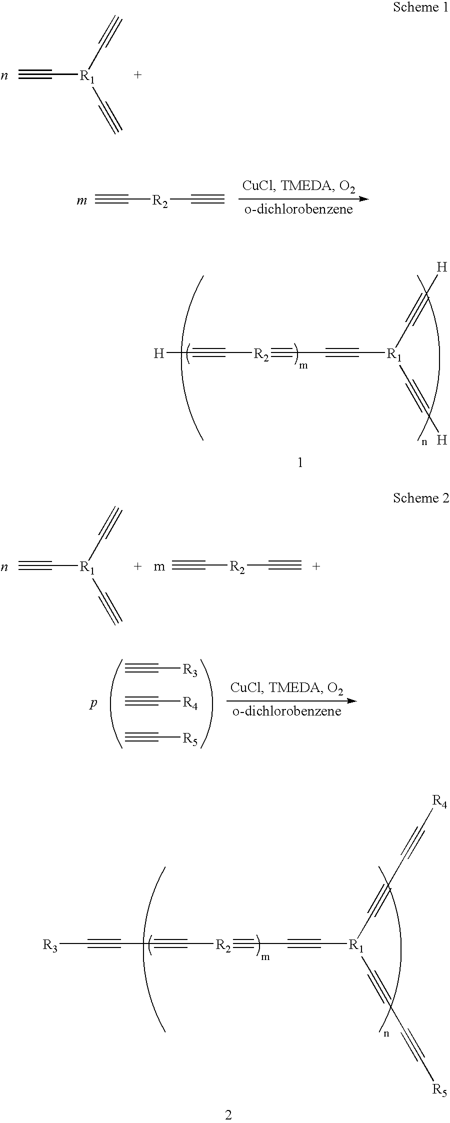

where R₁, R₂, R₃, R₄, R₅ can be any organic group (including aliphatic, aromatic, heteroaliphatic, and heteroaromatic) but preferably aromatic or heteroaromatic. Although in theory there is no limitation to n, m, p, there are obviously practical limitations. The following are reasonable ranges:
1≦n≦10000, preferably 1≦n≦100;
0≦m≦10000, preferably 0≦m≦1000; and
0≦p≦n+2

Another object of the present invention is exploration of optical properties by incorporation of suitable chromophors into the n-conjugated polymers of the present invention and their use as light-emitting and/or hole-transporting layer for light-emitting devices. In some embodiments, the high structural density of the diacetylene moieties endows them with high photo-refractivity (n=1.80) compared to the narrow range (n=1.45-1.65) of commodity organic polymers such as polystyrene (PS, n=1.59), polymethylmethacrylate (PMMA, n=1.49) or polycarbonate (PC, n=1.58). This feature is of significance to photonic applications such as wave-guides or high-refractive coatings of solar cells.

Still another object is the versatile use of the polyyne backbone of the polymers of the present embodiments as macroligand for the incorporation of other species such as metal-carbonyls. The formation of such hybrid structures will lead to high metal-loaded organometallic polymers with catalytic, electrical and/or magnetic properties. Upon pyrolization at elevated temperatures these hybrid-polymers are transformable into ceramics with high char yields and consequently with a high metal retention. The newly formed inorganic materials consist of mainly metal nanoparticles as cores, wrapped by a protecting carbon shell, and show high soft-magnetizability, stable under ambient conditions.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF THE DRAWINGS

FIG. 1 shows IR spectra of tris(4-ethynylphenyl)amine (A) and its copolymer I (B).

FIG. 2 shows 1H NMR spectra of polyyne II of the present invention (A) and its fully end-capped product X in chloroform-d (B).

FIG. 3 shows absorption spectra of THF solutions of tris(4-ethynylphenyl)amine and its homopolymer II (c=0.012 mg/mL) and emission spectrum of the polyyne II solution (λₑₓ=368 nm).

FIG. 4 shows wavelength dependence of refractive index of a thin film of polyyne II and comprising data for a thin film of polystyrene (PS).

FIG. 5 shows TGA thermograms of polyynes IX, II, I, and X of the present invention recorded under nitrogen at a heating rate of 20° C./min.

FIG. 6 shows DSC thermograms of polyynes II, VI, and IX of the present invention recorded under nitrogen at a heating rate of 10° C./min.

FIG. 7 shows electronic absorption and light emission spectra of a dichloromethane solution of polyyne I (Polymer concentration: 0.012 mg/mL. Excitation wavelength: 400 nm).

FIG. 8 shows plots of magnetization (M) versus applied magnetic field (H) at 300 K for magnetoceramics XIII and XIV of the present invention (insets: enlarged portions of the M-H plots of XIII and XIV in the low strength region of the applied magnetic field).

### DETAILED DESCRIPTION OF PARTICULAR EMBODIMENTS

(A) Process of Making the Compounds of the Present Invention

In some embodiments, compounds of the present invention can be made according to the following scheme (wherein n, m, R₁ and R₂ are as defined above):

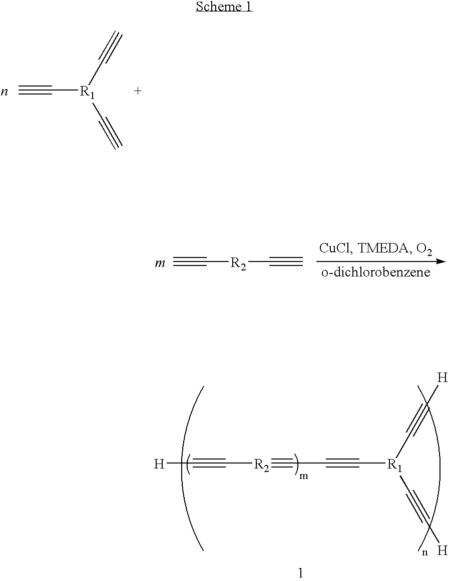

As shown, the scheme is not limited to only triethynylbenzene but can be extended to every compound possessing three or more polymerizable acetylene functionalities, preferably if they are connected to aromatic or other conjugated structural units. As shown in scheme 2, processable materials can be obtained by homo and copolymerization of triynes with monoynes and diynes in different ratios by choosing and optimizing the reaction conditions such as solvent, polymerization time, temperature, concentration of monomers and catalyst and purity of oxygen.

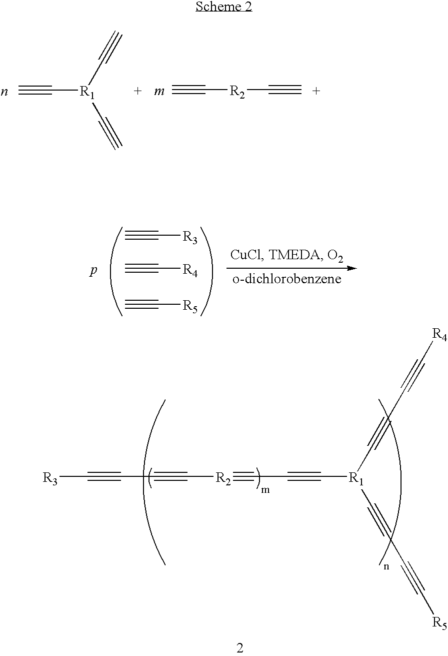

where R₁ and R₂ are each independently any organic group; R₃, R₄ and R₅ are each independently selected from the group consisting an aliphatic group, an aromatic group, a heteroaliphatic group and a heteroaromatic group); 1≦n≦10000; 0≦m≦10000; 0≦p≦n+2.

Shown in scheme 3, as a specific example, to increase the structural variety, processability and stability the peripheral terminal triple bonds (formula (I), R₃, R₄ or R₅=H) can be up to 100% end-capped by aromatic rings through palladium-catalyzed coupling with iodides and bromines (2).

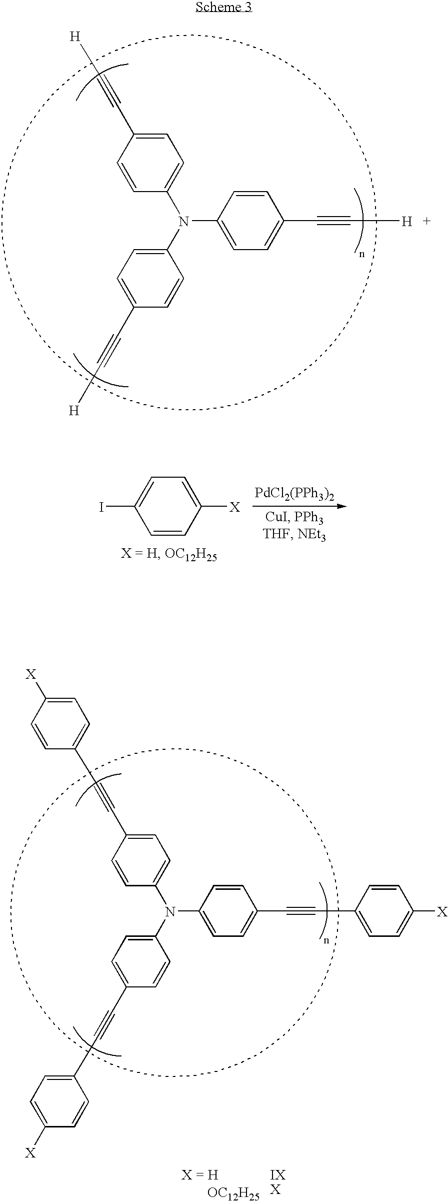

However, this reaction serves only as an example and every other chemical reaction involving monosubstituted triple bonds (RC≡CH) can be utilized to modify the periphery of the hyper-branched polymers and are covered by the present embodiments.

Based on the above schemes, specific compounds were made and shown in the following.

### EXAMPLE 1

### Hyperbranched poly{[tris(4-ethynylphenyl)aminelco-[(4-heptyloxy)phenyl-acetylene]}(I)

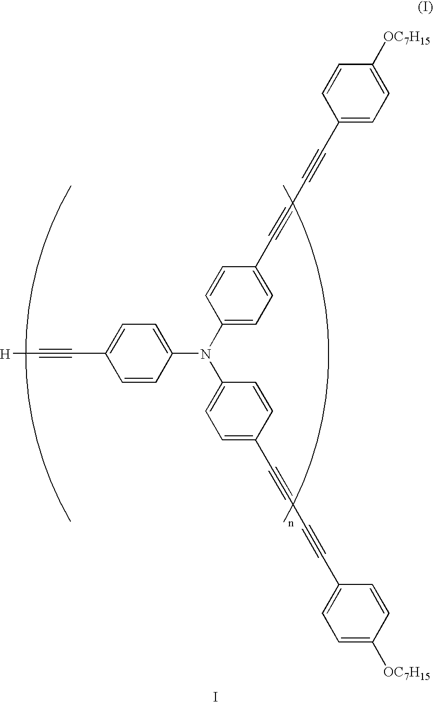

Into a 20 mL test tube equipped with a magnetic stirrer were placed 2 mg (0.02 mmol) CuCl and 8 mg (0.07 mmol) N,N,N′,N-tetramethylethylenediamine (TMEDA) in 4 mL o-dichlorobenzene (o-DCB). The catalyst mixture was bubbled with a slow stream of compressed air and stirred on an oil bath at 50° C. for 15 min. Tris(4-ethynylphenyl)amine (126.8 mg, 0.4 mmol) and (4-heptyloxy)phenyl-acetylene (129.6 mg, 0.6 mmol) were dissolved in 1 mL o-DCB and then added into the catalyst mixture. After 30 min, the polymerization was stopped by pouring the reaction mixture into 300 mL of methanol acidified with 1 mL of a 37 wt % HCl solution. The polymer precipitate was filtered by a Gooch crucible, washed with methanol and hexane, dried in vacuum overnight at room temperature and yielded 146.7 mg of a yellow powder.

Characterization Data: GPC (polystyrene calibration): M_{w} 18200; PDI 5.3. IR (KBr), v (cm⁻¹): 3293 (≡C—H stretching), 2924, 2852 (C—H stretching), 2207, 2142 (C≡C—C≡C stretching), 2104 (C≡C stretching), 639 (≡C—H bending). ¹H NMR (300 MHz, CDCl₃), δ (ppm): 7.3-7.5 (Ar—H), 6.9-7.1 (Ar—H), 4.0 (OCH₂), 3.1 (≡CH), 1.2-1.8 (CH₂), 0.9 (CH₃). ¹³C NMR (75 MHz, CDCl₃), δ (ppm): 159.65, 159.52, 146.89, 146.74, 146.56, 146.39, 133.85, 133.79, 133.54, 133.25, 133.21, 124.27, 124.05, 123.92, 123.69, 123.6, 123.28, 117.24, 117.01, 116.54, 116.24, 114.5, 113.26, 83.26, 82.09, 81.6, 80.82, 77.11, 74.22, 74.09, 72.78, 68.12, 31.86, 29.26, 29.15, 26.08, 22.74, 14.26.

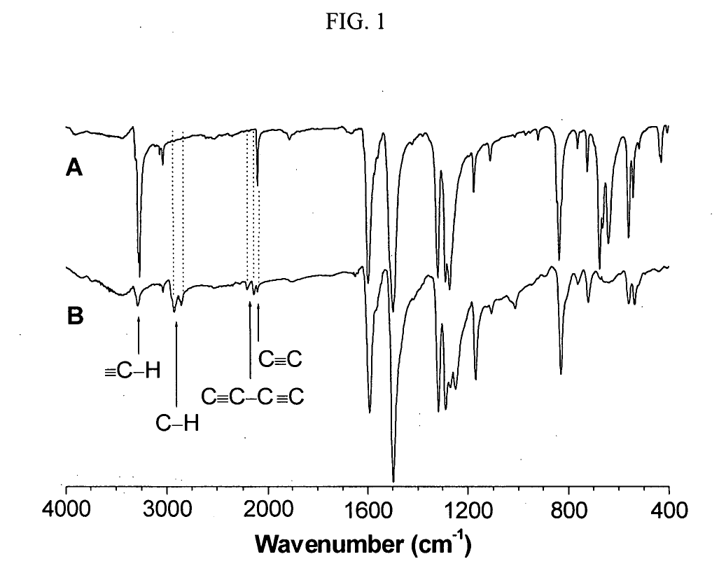

An IR spectrum of the hyperbranched polymer I, along with that of one of its monomer, is given in FIG. 1 as an example. From the comparison with the monomer spectrum, it is clear that the absorption bands of the copolyyne at 3293 and 2104 cm⁻¹ are associated with ≡C—H and C≡C vibrations, respectively. The bands at 2207 and 2142 cm⁻¹ are related to C≡C—C≡C stretching, confirming that the polycoupling reaction has taken place. The copolyyne exhibits vₐₛCH₃ and vₐₛCH₂ bands at 2924 and 2852 cm⁻¹, respectively, proving that the monoyne bearing the alkoxy tail has been copolymerized with the aryltriyne.

### EXAMPLE 2

### Hyperbranched poly[tris(4-ethynylphenyl)amine](II)

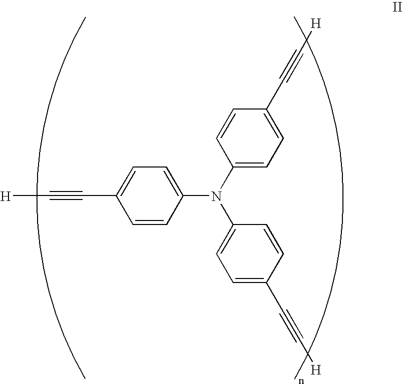

Homopolymerization of tris(4-ethynylphenyl)amine was carried out in accordance with the same procedure as described in Example 1 without the addition of (4-heptyloxy)phenyl-acetylene. A yellow powder was obtained after 10 min in 65.6 mg yield. GPC (polystyrene calibration): M_{w} 24100; PDI 1.6. IR (KBr), v (cm⁻¹): 3293 (≡C—H stretching), 2208, 2143 (C≡C—C≡C stretching), 2105 (C≡C stretching). ¹H NMR (300 MHz, CDCl₃), δ (ppm): 7.3-7.5 (Ar—H), 6.9-7.1 (Ar—H), 3.1 (≡CH). ¹³C NMR (75 MHz, CDCl₃), δ (ppm): 147.33, 147.13, 146.95, 146.8, 146.63, 133.74, 133.45, 133.4, 125.01, 124.49, 124.21, 124.07, 123.77, 123.44, 117.46, 117.16, 116.75, 116.4, 116.06, 83.32, 83.27, 81.73, 81.64, 81, 58, 77.25, 77.12, 74.25, 74.11, 73.95.

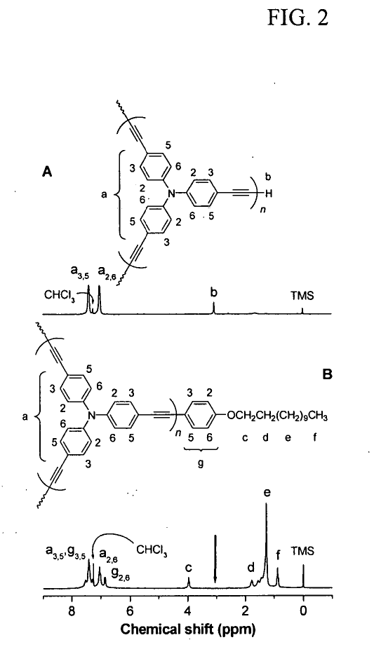

FIG. 2A shows a ¹H NMR spectrum of II, a homopolyyne, whose peaks are readily assignable: the resonance signals at δ 7.4, 7.0 (a), and 3.1 (b) are due to the absorptions of the aromatic and acetylenic protons, respectively.

As revealed by the spectroscopic analyses, both the homo- and copolyynes contain terminal triple bonds (cf. Examples 1-8), offering an opportunity to decorate the polymer peripheries by end-capping reactions. This is demonstrated by couplings of II with aryliodides (Scheme 3 above). The coupling of iodobenzene with the triple bonds proceeds smoothly at room temperature: the reaction product IX shows no vibration bands of terminal triple bonds, indicative of 100% end-capping. Although IX is soluble in the reaction solution, it becomes partially soluble after purification, possibly due to π-π stacking-induced supramolecular aggregation during the precipitation and drying processes. The coupling product of X with (4-dodecyloxy)iodobenzene, viz., X, remains soluble after purification, thanks to its long dodecyloxy group. The solubility enables its structural characterization by “wet” methods. As can be seen from FIG. 2B, its NMR peaks nicely correspond to its expected molecular structure. No signal of terminal acetylene resonance is observed at a 3.1, unambiguously attesting the completion of the end-capping reaction.

### EXAMPLE 3

### Hyperbranched poly(2-hexyloxy-1,3,5-triethynylbenzene) (III)

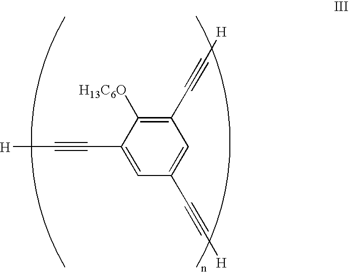

Homopolymerization of 2-hexyloxy-1,3,5-triethynylbenzene was carried out in accordance with the same procedure as described in Example 2 with 100 mg (0.4 mmol) 2-hexyloxy-1,3,5-triethynylbenzene instead of (4-ethynylphenyl)amine. A white powder was obtained after 20 min in 76.1 mg yield.

GPC (polystyrene calibration): M_{w} 30700; PDI 3.6. (IR (KBr), v (cm⁻¹): 3295 (≡C—H stretching), 2940, 2928 (C—H stretching), 2211 (C≡C—C≡C stretching), 648 (≡C—H bending). ¹H NMR (300 MHz, CDCl₃), δ (ppm): 7.4-7.7 (Ar—H), 4.4 (OCH₂), 3.3 (≡CH), 3.0 (═CH), 1.7-2.2 (OCH₂CH₂), 1.2-1.7 (CH₂), 0.9 (CH₃). ¹³C NMR (75 MHz, CDCl₃), 15 (ppm): 163.62, 138.89, 138.49, 117.42, 117.07, 116.57, 82.86, 82.6, 78.48, 78.35, 77.82, 77.21, 75.28, 75.03, 74.74, 31.64, 30.23, 25.62, 22.7, 14.08.

### EXAMPLE 4

Hyperbranched poly[tris(4-ethynylphenyl)phosphine oxide] (IV)

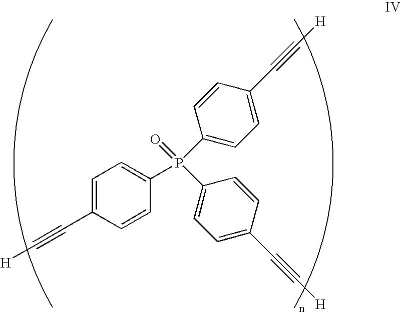

Homopolymerization of tris(4-ethynylphenyl) phosphine oxide was carried out in accordance with the same procedure as described in Example 2 with 140 mg (0.4 mmol) (4-ethynylphenyl)phosphine oxide instead of (4-ethynylphenyl)amine. A white powder was obtained after 10 min in 52.0 mg yield.

GPC (polystyrene calibration): M_{w} 5100; PDI 1.4. IR (KBr), v (cm⁻¹): 3291 (≡C—H stretching), 2212 (C≡C—C≡C stretching), 2102 (C≡C stretching), 646 (≡C—H bending). ¹H NMR (300 MHz, CDCl₃), δ (ppm): 7.5-7.6 (Ar—H), 3.2 (≡CH). ¹³C NMR (75 MHz, CDCl₃), δ (ppm): 132.46, 132.3, 132.17, 132.13, 131.97, 131.83, 131.71, 131.59, 130.96, 130.78, 126.27, 136.22, 125.48, 82.32, 81.45, 80.29, 76.25. ³¹P NMR (121.48 MHz, CDCl₃), δ (ppm): 28.86, 28.71, 28.56.

### EXAMPLE 5

### Hyperbranched poly{(1,3,5-triethynylbenzene)-co-[(4-heptyloxy)phenylacetylene)]} (V)

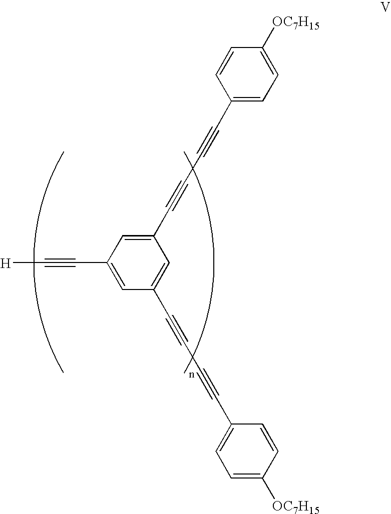

Copolymerization of 1,3,5-triethynylbenzene with (4-heptyloxy)phenylacetylene was carried out in accordance with the same procedure as described in Example 1 with 60 mg (0.4 mmol) 1,3,5-triethynylbenzene instead of (4-ethynylphenyl)amine. A white powder was obtained after 30 min in 89.0 mg yield.

GPC (polystyrene calibration): M_{w} 17900; PDI 4.7. IR (KBr), v (cm⁻¹): 3295 (≡C—H stretching), 2927, 2855 (C—H stretching), 2216, 2145 (C≡C—C≡C stretching). ¹H NMR (300 MHz, CDCl₃), δ (ppm): 7.4-7.6 (Ar—H), 6.9-7.1 (Ar—H), 4.0 (O—CH₂), 3.1 (≡CH), 1.2-1.8 (CH₂), 0.9 (CH₃).

### EXAMPLE 6

### Hyperbranched poly{[tris(4-ethynylphenyl)phenylsilane]-co-[(4-heptyloxy)phenylacetylene]} (I)

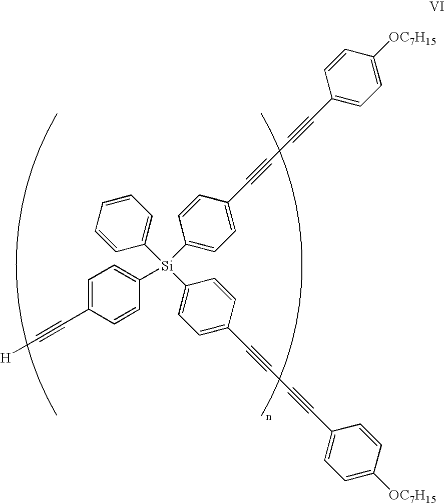

Copolymerization of tris(4-ethynylphenyl)phenylsilane with (4-heptyloxy)phenylacetylene was carried out in accordance with the same procedure as described in Example 1 with 81.6 mg (0.4 mmol) tris(4-ethynylphenyl)phenylsilane instead of (4-ethynylphenyl)amine. A white powder was obtained after 30 min in 142.5 mg yield. White powder: yield 67.4%. M_{w} 13000, PDI 7.2 (GPC, polystyrene calibration). IR (KBr), v (cm⁻¹): 2924, 2853 (C—H stretching), 2211, 2142 (C≡C—C≡C stretching). ¹H NMR (300 MHz, CDCl₃), δ (ppm): 7.3-7.6 (Ar—H), 6.9-7.1 (Ar—H), 4.0 (OCH₂), 3.1 (≡CH), 1.2-1.8 (CH₂), 0.9 (CH₃). ¹³C NMR (75 MHz, CDCl₃), δ (ppm): 160.06, 159.82, 136.15, 136.12, 135.13, 135.05, 134.63, 134.54, 134.46, 134.13, 133.98, 131.81, 131.72, 130.18, 123.66, 123.25, 114.66, 114.61, 113.64, 113.22, 82.64, 81.88, 81.3, 80.7, 75.52, 75.09, 72.87, 72.6, 68.13, 31.74, 29.11, 29.01, 25.93, 22.58, 14.06.

### EXAMPLE 7

### Hyperbranched poly{[tris(4-ethynylphenyl)phosphine oxide]-co-[(4-heptyloxy)phenylacetylene]} (VII)

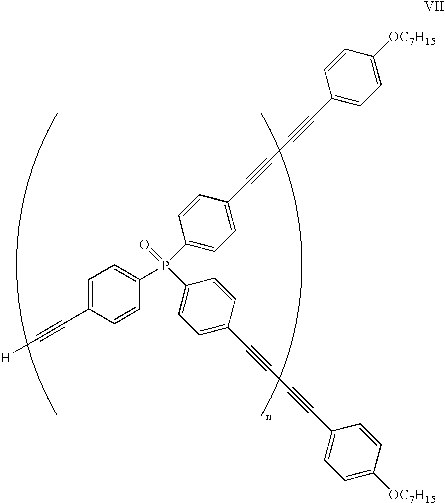

Copolymerization of tris(4-ethynylphenyl) phosphine oxide with (4-heptyloxy)phenylacetylene was carried out in accordance with the same procedure as described in Example 1 with 140 mg (0.4 mmol) tris(4-ethynylphenyl) phosphine oxide instead of (4-ethynylphenyl)amine. A white powder was obtained after 17 min in 51.3 mg yield.

GPC (polystyrene calibration): M_{w} 7500, PDI 1.4. IR (KBr), v (cm⁻¹): 3291 (≡C—H stretching), 2928, 2856 (C—H stretching), 2211 (C≡C—C≡C stretching), 2104 (C≡C stretching), 646 (≡C—H bending). ¹H NMR (300 MHz, CDCl₃), δ (ppm): 7.5-7.7 (Ar—H), 7.4 (Ar—H) 6.8 (Ar—H), 4.0 (OCH₂), 3.2 (—CH), 1.6-1.9 (OCH₂CH₂), 1.2-1.5 (CH₂), 0.9 (CH₃). ³¹P NMR (121.48 MHz, CDCl₃), δ (ppm): 28.75, 28.60, 26.45.

### EXAMPLE 8

### Hyperbranched poly{[tris(4-ethynylphenyl)amine]-co-[(9,9′-di-n-hexyl)-2,7-diethynylfluorene]} (VIII)

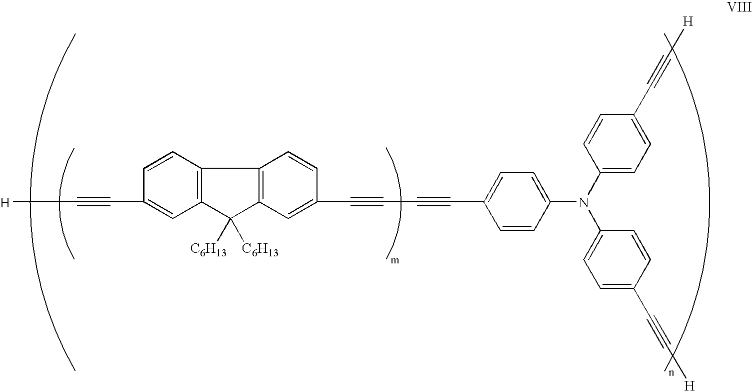

Copolymerization of tris(4-ethynylphenyl)amine with (9,9′-di-n-hexyl)-2,7-diethynylfluorene was carried out in accordance with the same procedure as described in Example 1 with 95.1 mg (0.3 mmol) tris(4-ethynylphenyl)amine and 38.2 mg (0.1 mmol) (9,9′-di-n-hexyl)-2,7-diethynylfluorene instead of (4-heptyloxy)phenyl-acetylene. A yellow powder was obtained after 5 min in 129.1 mg yield.

GPC (polystyrene calibration): M_{w} 20100, PDI 3.6. IR (KBr), v (cm⁻¹): 3295 (≡C—H stretching), 2926, 2854 (C—H stretching), 2206 (C≡C—C≡C stretching), 2141 and 2106 (C≡C stretching), 646 (≡C—H bending). ¹H NMR (300 MHz, CDCl₃), δ (ppm): 7.4-7.7 (Ar—H), 6.9 (Ar—H), 4.0 (OCH₂), 3.2 (≡CH), 1.6-1.9 (OCH₂CH₂), 1.2-1.5 (CH₂), 0.9 (CH₃). ¹³C NMR (75 MHz, CDCl₃), δ (ppm): 151.25, 147.15, 141.28, 133.8, 131.68, 126.87, 124.19, 120.22, 117.51, 116.40, 84.46, 83.31, 81.88, 74.09, 55.25, 40.19, 31.46, 29.60, 23.68, 22.55, 13.96.

### EXAMPLE 9

### Hyperbranched poly[tris(4-ethynylphenyl)amine] endcapped with iodobenzene (IX)

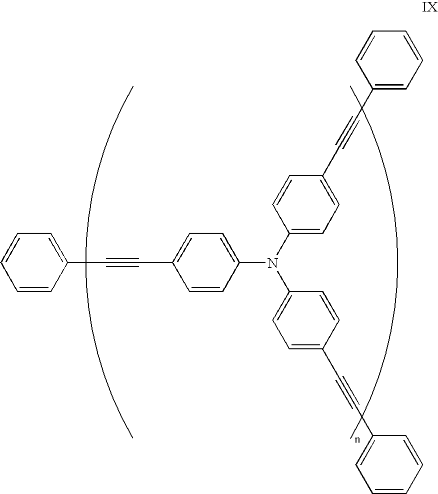

To a 10 mL Schlenk tube were added 40 mg of a hyperbranched poly[tris(4-ethynylphenyl)amine] (about 0.13 mmol of C≡CH unit according to ¹H NMR analysis), 1 mg of CuI and 1 mg of Pd(PPh₃)₂Cl₂ under nitrogen. After all the reagents were dissolved in 5 mL THF with a small amount of NEt₃, 0.1 mL of iodobenzene was added. The resultant solution was stirred for 8 h at room temperature. The end-capped polyyne was purified by precipitation into 100 mL of methanol through a cotton filter under stirring. The polymer precipitate was filtered by a Gooch crucible, washed with methanol, acetone, diethyl ether and hexane, and dried under vacuum to a constant weight.

characterization Data. IR (KBr), v (cm⁻¹): 2208, 2144 (C≡C—C≡C stretching).

### EXAMPLE 10

### Hyperbranched poly[tris(4-ethynylphenyl)amine] endcapped with (4-dodecyloxy)iodobenzene

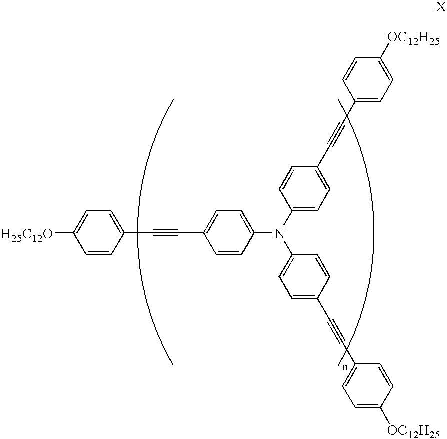

The endcapping reaction was carried out in accordance with the same procedure as described in Example 8 with using 0.15 mL of (4-dodecyloxy)iodobenzene instead of iodobenzene.

Characterization Data: IR (KBr), v (cm⁻¹): 2923, 2852 (C—H stretching), 2207, 2143 (C≡C—C≡C stretching). ¹H NMR (300 MHz, CDCl₃), δ (ppm): 7.3-7.6 (Ar—H), 6.9-7.1 (Ar—H), 6.7-6.9 (Ar—H), 3.9 (OCH₂), 1.7-1.9 (OCH₂CH₂), 1.2-1.6 (CH₂), 0.8-0.9 (CH₃).

### EXAMPLE 11

### Incorporation of dicobaltoctacarbonyl into hyperbranched poly[tris(4-ethynylphenyl)amine] (XI)

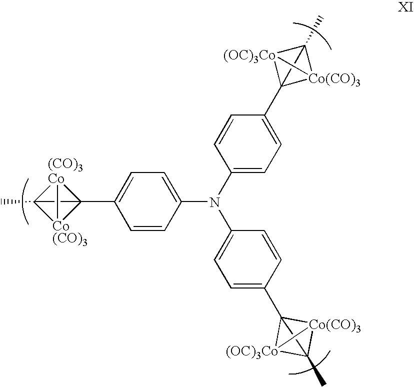

In a typical run for the preparation of cobalt-polyyne complex XI, 30 mg of polymer II (from Example 2) was dissolved under nitrogen in 4 mL of THF in a 10 mL test tube, into which 1 mL of a THF solution of Co₂(CO)₈ (146.3 mg, 0.43 mmol or 1.5 molar equiv to the C≡C units of polymer II) was added. The mixture was stirred at room temperature for 1 h and was then added dropwise into a large amount of hexane (about 200 mL) through a cotton filter under stirring. The precipitate of polyyne complex XI was washed with hexane three times and dried under vacuum to a constant weight. Brown solid; yield: 54.8%.

Characterization Data: IR (KBr), v (cm⁻¹): 2208, 2144 (C≡C—C≡C stretching), 2090, 2055, 2025 (C═O).

### EXAMPLE 12

### Incorporation of cyclopentadienylcobaltdicarbonyl into hyperbranched poly[tris(4-ethynylphenyl)amine] (XII)

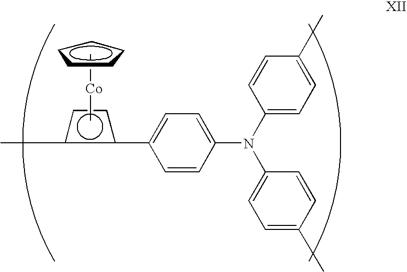

Polyyne complex XII was prepared by complexation of CpCo(CO)₂ with polymer II under similar reaction conditions as described in Example 11. Brown solid; yield: 59.5%.

Characterization Data: IR (KBr), v (cm⁻¹): 2205, 2141 (C≡C—C≡C stretching).

(B) Utilities of the Compounds of the Present Invention

Transparent films, showing high transmittance in the long wavelength region, can be obtained for the polymers of the present invention from common inexpensive organic solvents such as toluene, chloroform or tetrahydrofuran by common inexpensive coating methods (e.g. spin-coating).

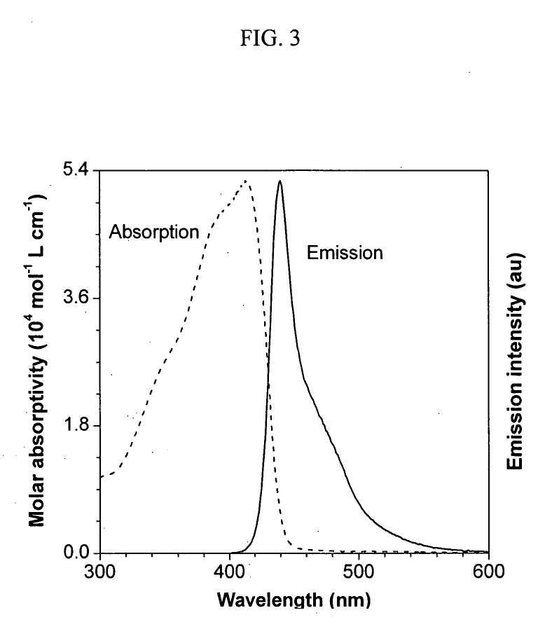

The hyper-branched polyynes exhibit extensively π-conjugation, often provides interesting optical properties and phenomena. For instance, compound II emits bright blue light (λₑₘ=440 nm) with a luminance easily going beyond 1000 cd/m² when the polyyne is excited by a weak UV lamp with a power of merely 30 mW/cm². As shown in FIG. 3, the absorption maximum (λ_{ab}) of II locates at 413 nm, which is indicative of extensive π-conjugation in the polyyne system. The polyyne emits a blue light of 440 nm upon excitation. The blue emission is bright, with luminance easily going beyond 1000 cd/m² when the polyyne is excited by a weak UV lamp with a power of merely 30 mW/cm².

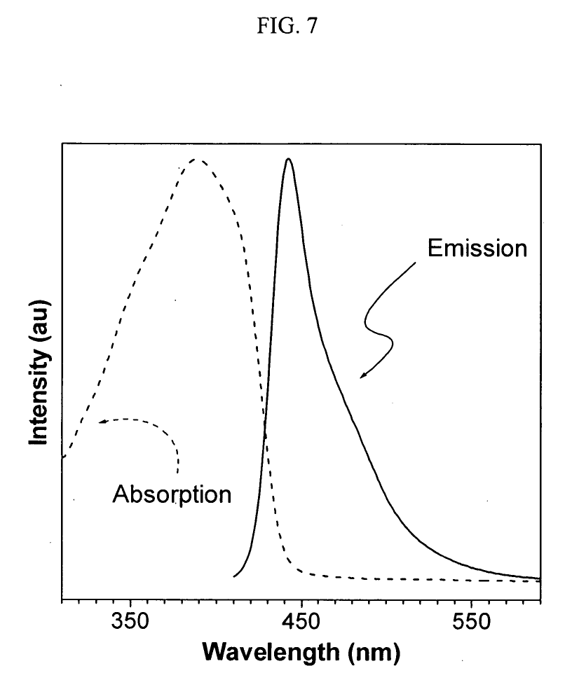

Furthermore, the absorption and emission spectra of compound II resemble those of its homopolymer counterpart compound I (shown in FIG. 7), suggesting that the monoyne comonomer exerts little effect on the electronic transitions of the copolyyne.

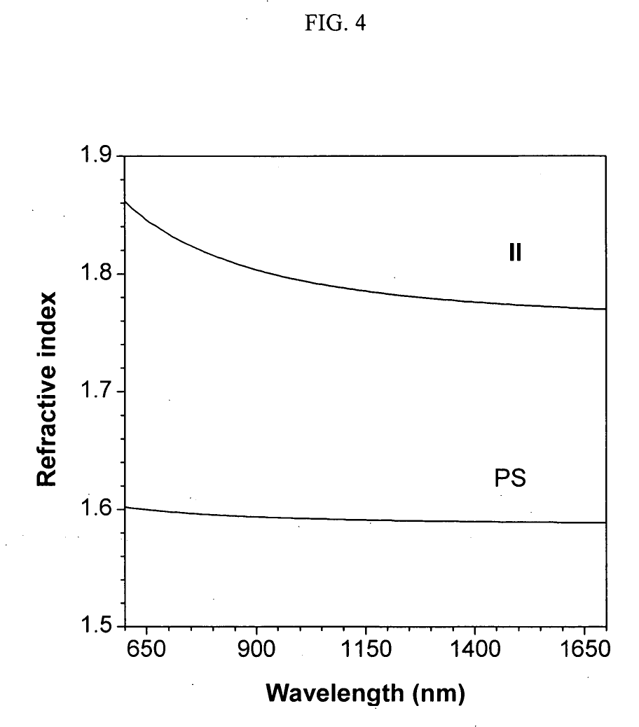

Advanced photonic devices are often composed of working parts with high contrast of refractive index (RI). The RIs of existing polymers, however, vary in a small range (1.34-1.71) (J. C. Seferis, In Polymer Handbook, 3rd ed.; Brandrup, J., Immergut, E. H., Eds.; Wiley: New York, 1989; pp VI/451-VI/461.; N.J. Mills, In Concise Encyclopedia of Polymer Science &Engineering; Kroschwitz, J. I., Ed.; Wiley: New York, 1990; pp 683-687), which limits the scope of their photonic applications. It is believed that macromolecules consisting of groups with high polarizabilities and small volumes, like the ones of the present invention, can exhibit high refractivities. For example, polyyne compound II is comprised of electronically mobile aromatic rings and dimensionally slim triple-bond bars and was found to possess high RIs and, as shown in FIG. 4, a thin film of II shows RI values of 1.861-1.770 in the spectral region of 600-1700 nm, which are much higher than those of well-known “organic glasses” such as polystyrene (n=1.602-1.589), poly(methyl methacrylate) (1.497-1.489), and polycarbonate (1.593-1.576). The bright light emission and the high refractive index makes the materials of the present invention useful for different kinds of optical device applications such as light-emitting or hole-transporting layer of OLEDs and as high refractive index layers in waveguides.

The carbon-rich polyynes of the present invention and their films are readily curable (from about 150° C.), and they form solvent/moisture resistant materials and films, without any gas evolution, which is highly desired for coating and adhesive applications. The materials of the present invention are thermally stable (T_{d} up to about 550° C.), and pyrolytic carbonizable (Wᵣ up to about 80% at 900° C.).

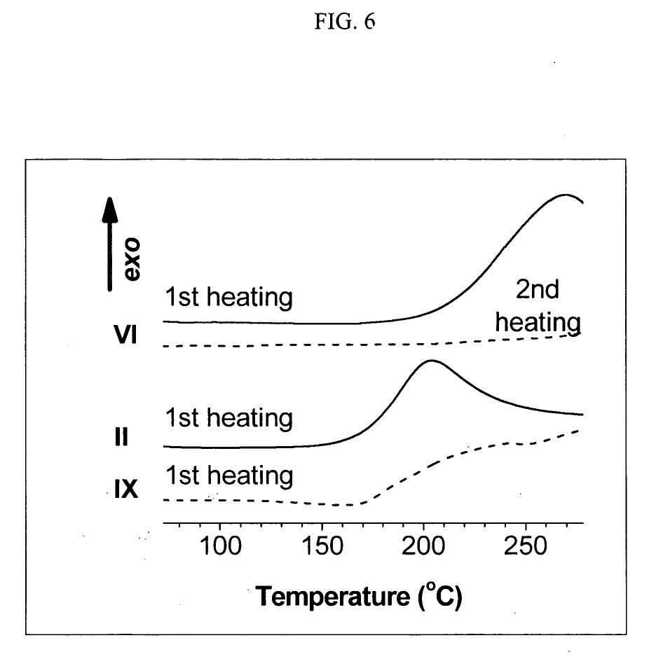

Polymers containing diyne moieties readily crosslink upon moderate heating and many monoyne-terminated oligomers or prepolymers have been easily converted to thermoset networks. The homo- and copolyynes carry both di- and monoyne moieties and can undergo facile thermal curing reactions. As indicated in FIG. 6, when compound VI is heated in a differential scanning calorimeter (DSC) cell, it starts to release heat at about 200° C. due to the commencement of thermally induced alkyne polymerizations. The exothermic reaction peaks at about 270° C. The second heating scan of the DSC analyses detects almost a flat line parallel to the abscissa in the same temperature region, suggesting that all the triple bonds have reacted during the 1st heating scan. The crosslinking reaction of II starts from about 150° C. and peaks at about 204° C. Without being bound to a particular theory, it is believed that the easier curing of homopolyyne II over copolyyne VI is because the former has more reactive terminal acetylene peripheries and sterically less crowded aryl cores. When the terminal acetylene groups of II are end-capped by phenyl groups, the resulted IX now contains only internal acetylene groups, which needs higher temperatures to drive its thermal curing to completion, further manifesting the effect of the acetylene reactivity on the thermal curability of the polyynes.

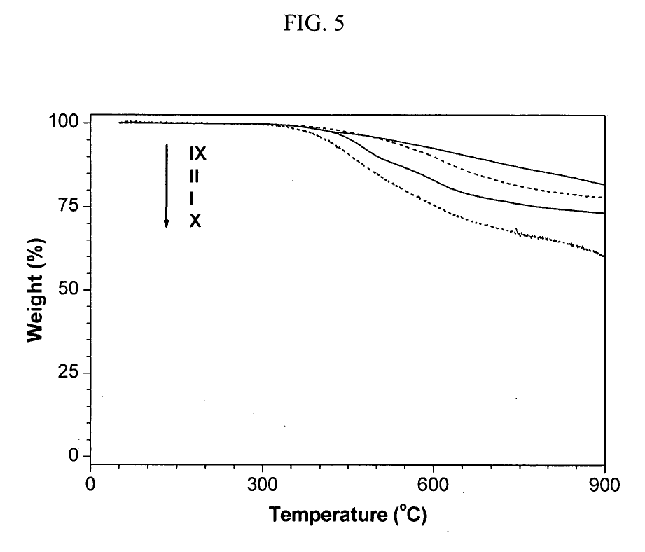

The thermal curing makes the hyperbranched polyynes highly resistant to thermal composition. The temperature for 5% weight loss (T_{d}) and the weight residue at 900° C. (Wᵣ) for the polyynes are high, being 377-549° C. and 50.4-78.0%, respectively (see Table 1). Among the polyynes, IV is most stable, which loses little weight when heated to about 550° C. and retains 84% of its original weight when pyrolyzed at 850° C. When the thermal stabilities of the II family are compared, it is clear that the polyyne end-capped by the robust phenyl ring (IX) is more stable than its parent form (II), whereas the polymers bearing the flexible alkoxy chains (I and X) are less stable: the longer the alkoxy chain, the easier the polymer degradation (see FIG. 5).

TABLE 1
Syntheses^{a} and properties of (hyper)branched polyynes

| | | time | yield | | | T_{d}^{c} | |
|---|---|---|---|---|---|---|---|
| entry | polyyne | (min) | (%) | M_{w}^{b} | PDI^{b} | (° C.) | Wᵣ^{d} (%) |
| homopolymer | | | | | | | |
| 1 | III | 20 | 76.1 | 30 700 | 3.6 | 377 | 50.4 |
| 2 | II | 10 | 51.7 | 24 100 | 1.6 | 516 | 78.0 |
| 3 | IV | 10 | 37.1 | 5 100 | 1.4 | 549 | 84.0^{e} |
| copolymer | | | | | | | |
| 4 | V | 30 | 46.9 | 17 900 | 4.7 | 412 | 60.3 |
| 5 | VI | 30 | 67.4 | 13 000 | 7.2 | 411 | 59.2 |
| 6 | I | 30 | 57.2 | 18 200 | 5.3 | 456 | 73.3 |
| 7 | VII | 17 | 19.1 | 7 500 | 1.4 | 430 | 65.9 |
| 8 | VII | 5 | 96.8 | 20 100 | 3.6 | 390 | 0 |

^{a}Carried out at 50° C. with air bubbling through the reaction mixtures; [triyne] = 80 mM; [CuCl] = 4 mM, [TMEDA] = 13.8 mM. For copolycoupling, [triyne]/[monoyne] = 1:1.5.
^{b}Determined by GPC on the basis of a polystyrene calibration.
^{c}Temperature for 5% weight loss.
^{d}Weight residue at 900° C. unless otherwise specified.
^{e}At 850° C.

Acetylene triple bonds are versatile ligands in organometallic chemistry and complexations with cobalt carbonyls easily metallify the hyper-branched polyynes. Since only gaseous carbon monoxide evolves as a side-product from the reaction mixture, organometallic films are easily prepared by direct usage of the dissolved organometallic polymers without the necessity of further purification steps according to the following process:

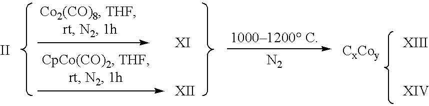

Metallic nanoparticles are currently a frontier in material science and the preparation of controlled sizes is highly desired. Thanks to the molecular scaffolding of the hyperbranched polyyne backbone structure, ceramizations of the cobalt-polyyne complexes under protective gases such as nitrogen or argon afford nanosized cobalt particles embedded in a graphite and/or amorphous carbon matrix. Depending on the ceramization conditions (e.g. pyrolysis time and temperature), the growth of the nanoparticles can be easily controlled. As an example, pyrolyzing the organometallic complexes in a tube furnace for 1 h at 1200° C. under nitrogen furnishes cobalt nanoparticles with an average size of 33 nm, which are soft ferromagnetic materials with high magnetizability (Mₛ up to about 118 emu/g) and low coercivity (H_{c} down to about 0.045 kOe). The hyperbranched polyynes are excellent precursors for the preparation of cobalt nanoparticles. The following are examples of making ceramics with the polymers of the present invention.

Magnetoceramic from Co₂(CO)₆-Precursor

Ceramic XIII was fabricated from polyyne precursor XI by pyrolysis in a Lindberg/Blue tube furnace with a heating capacity up to 1700° C. In a typical ceramization experiment, 166.9 mg of XI was placed in a porcelain crucible, which was heated to 1200° C. at a heating rate of 10° C./min under a steam of nitrogen (0.2 L/min). The sample was sintered for 1 h at 1200° C. and black ceramic XIII was obtained in 42.4% yield (70.7 mg) after cooling.

Magnetoceramic from CpCo-Precursor (XIV)

Ceramics XIV was prepared by a similar pyrolysis procedure from polyyne precursor XII at a temperature of 1000° C. Yield: 64.8%.

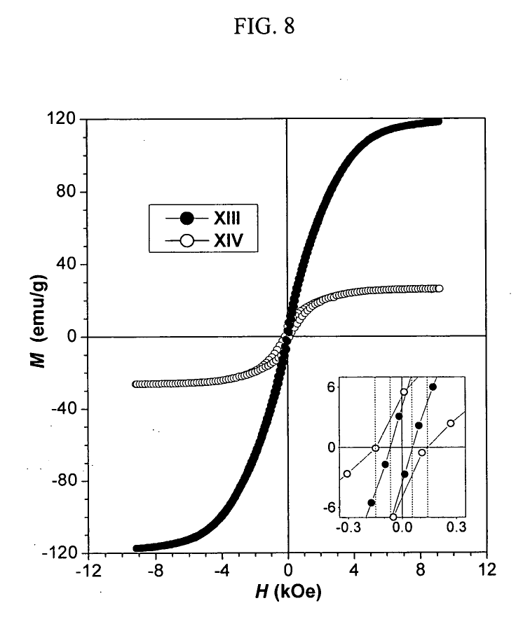

FIG. 8 shows magnetization curves of the ceramics XIII and XIV. With an increase in the magnetic strength of external field, the magnetization of ceramic XIII swiftly increases and ultimately levels off at a saturation magnetization (Mₛ) of about 118 emu/g. The Ms value of ceramic XIII (about 26 emu/g) is lower, which is understandable, because the cobalt content of its precursor complex XII is lower. The hysteresis loops of the magnetoceramics are small. From the enlarged H-M plots shown in the insets of FIG. 8, the coercivities (H_{c}) of XIII and XIV are found to be 0.058, and 0.142 kOe, respectively. An Hc value as low as 0.045 kOe is observed in the magnetization of a ceramic made from the complex of 1× and Co₂(CO)₈ with a Co₂(CO)₈]/[C≡C] feed ratio of 1:1, suggesting that the low coercivity is a general property of this family of magnetic ceramics. A ferromagnetic material with a coercivity smaller than 0.126 kOe (10⁴ A/m) is termed a soft magnet.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claimed is:

1. A diacetylene polymer of formula (I): 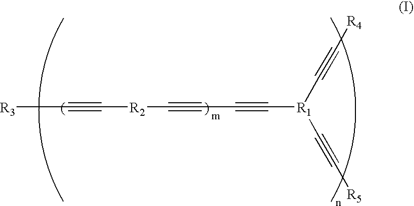
wherein R₁ and R₂ are each independently any organic group; R₃, R₄ and R₅ are each independently selected from the group consisting H, an aliphatic group, an aromatic group, a heteroaliphatic group and a heteroaromatic group); wherein m is ≧0; n≧1; and wherein said polymer has a molecular weight larger than about 10,000 Daltons.

2. The polymer of claim 1, wherein 0≦m≦10000 and 1≦n≦10000.

3. The polymer of claim 2, wherein 0≦m≦11000 and 1≦n≦1100.

4. The polymer of claim 3, wherein m=0;

5. The polymer of claim 1, wherein said R₁ is selected from the group consisting of:

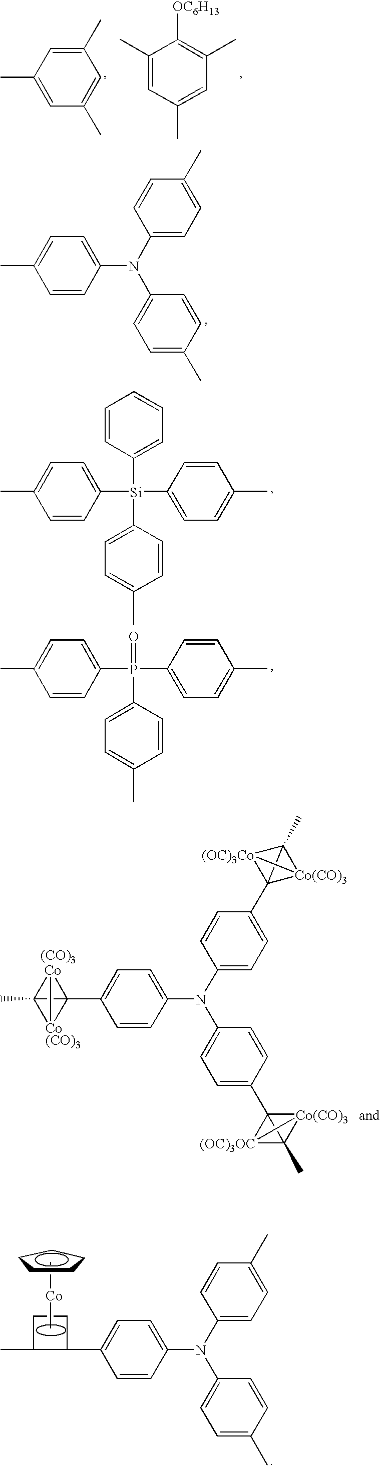

6. The polymer of claim 5, wherein R₂ is

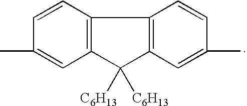

7. The polymer of claim 5, wherein said R₃, R₄ and R₅ are each independently—H, —C≡C—H, —C₆H₅, —C₆H₄—OC₁₂H₂₅ or —C≡C—C₆H₄—OC₇H₁₅.

8. The polymer of claim 1, which is selected from the group consisting of:
hyperbranched poly {[tris(4-ethynylphenyl)amine]co-[(4-heptyloxy)phenyl-acetylene]};
hyperbranched poly[tris(4-ethynylphenyl)amine];
hyperbranched poly(2-hexyloxy-1,3,5-triethynylbenzene);
hyperbranched poly[tris(4-ethynylphenyl)phosphine oxide];
hyperbranched poly {(1,3,5-triethynylbenzene)-co-[(4-heptyloxy)phenylacetylene)]};
hyperbranched poly {[tris(4-ethynylphenyl)phenylsilane]-co-[(4-heptyloxy)phenylacetylene]};
hyperbranched poly{[tris(4-ethynylphenyl)phosphine oxide]-co-[(4-heptyloxy)phenylacetylene]};
hyperbranched poly {[tris(4-ethynylphenyl)amine]-co-[(9,9′-di-n-hexyl)-2,7-diethynylfluorene]};
hyperbranched poly[tris(4-ethynylphenyl)amine] endcapped with iodobenzene;
hyperbranched poly[tris(4-ethynylphenyl)amine] endcapped with (4-dodecyloxy)iodobenzene;
hyperbranched poly[tris(4-ethynylphenyl)amine] incorporated with dicobaltoctacarbonyl; and
hyperbranched poly[tris(4-ethynylphenyl)amine] incorporated with cyclopentadienylcobaltdicarbonyl;

9. A method of making a ceramic, comprising a pyrolysis procedure using at least one polyyne precursor which is a diacetylene polymer of claim 1.

10. The method of claim 9, wherein said polyyne precursor is hyperbranched poly[tris(4-ethynylphenyl)amine] incorporated with dicobaltoctacarbonyl or hyperbranched poly[tris(4-ethynylphenyl)amine] incorporated with cyclopentadienylcobaltdicarbonyl.

11. A method of making a diacetylene polymer of claim 1, using a synthetic scheme selected from the group consisting of scheme 1 and scheme 2: 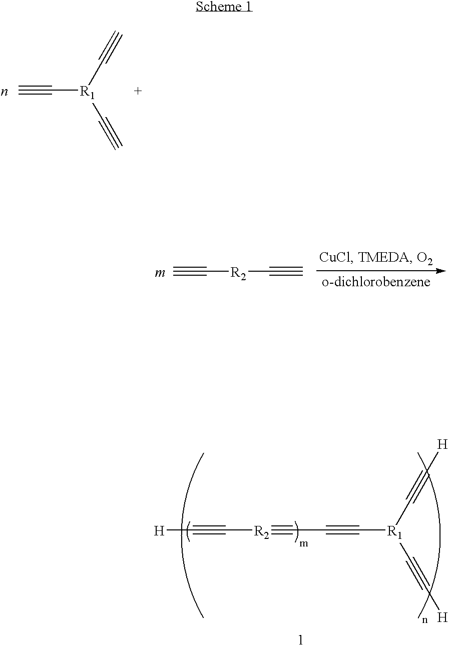 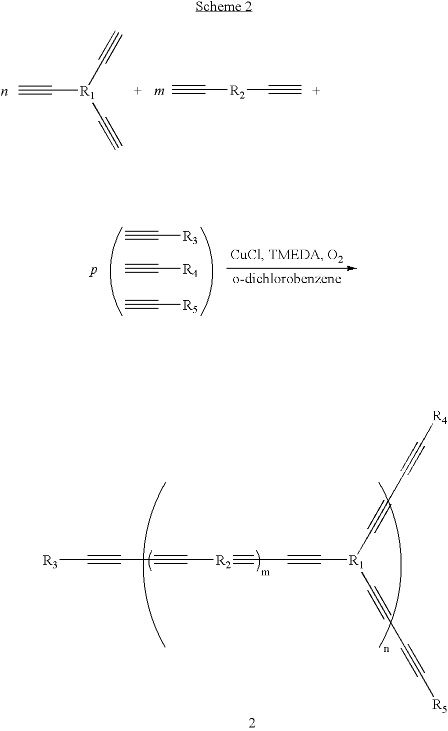
wherein R₁ and R₂ are each independently any organic group; R₃, R₄ and R₅ are each independently selected from the group consisting an aliphatic group, an aromatic group, a heteroaliphatic group and a heteroaromatic group); and wherein 1≦n≦10000; 0≦m≦10000; 0≦p≦n+2.

12. A film material, comprising the diacetylene polymer of claim 1, which is used as a working part of a device or is coated on a surface of a structure element.

13. A photonic device comprising the film material of claim 12.

14. The photonic device of claim 13 wherein the film material exhibits refractive index values from about 1.7 to about 2.0 in the spectral region of 600-1700 nm.

15. An organic light-emitting diode comprising the film material of claim 12, wherein the film material is used as a light-emitting or hole-transporting layer.

16. A waveguide comprising the film material of claim 12, wherein the film material is used as a refractive layer.

17. A structure element comprising the film material of claim 12, wherein the film material is coated on the structural element and wherein the film material exhibits a blue light upon excitation with luminance greater than about 1000 cd/m².

18. The structure element of claim 17, wherein the film material resists thermal decomposition.
